(19) United States
(12) Patent Application Publication
(10) Pub. No.: US 2012/0181318 A1
(43) Pub. Date: Jul. 19, 2012

(54) Radio Holster with Antenna Lanyard

(76) Inventors: Ryan Mongan, Orange, CA (US); Juan Sadder, Seattle, WA (US); Scott Comins, Seattle, WA (US); Graeme Esarey, Seattle, WA (US)

(21) Appl. No.: 13/351,480

(22) Filed: Jan. 17, 2012

Related U.S. Application Data
(60) Provisional application No. 61/461,452, filed on Jan. 19, 2011.

(51) Int. Cl. F16G 11/00; A45F 5/00

(52) U.S. Cl. 224/665

(57) ABSTRACT

A method and apparatus for securely carrying a radio device. A radio device is placed in a holster which is attached to a belt worn around the waist of the user. The holster employs a lanyard assembly having a first attachment member which attaches to the antenna of the radio device and a second attachment member which attaches to the holster. The distance between the first attachment member and second attachment member of the lanyard assembly can be adjusted. enabling the holster to accommodate a multitude of radio device sizes.

### RELATED APPLICATION

The current application is related to (continuation of) a prior provisional application 61/461,452, filed on Jan. 19, 2011. with the same inventors and a similar title, taking benefits of all teachings and earlier filing date of that application. A reassignment to D4 Brands, LLC has been made and can be referred to by the EPAS ID#: PAT1761603.

### BACKGROUND OF THE INVENTION

Person to person radio holsters or holders are commonly used by uniformed professional field personnel (e.g. law enforcement, fire, park department, search and rescue, private security, utilities personnel, military. etc.) to carry radio devices. These holsters are attached to a duty belt worn around the waist of the user. The typical holster used by uniformed professional field personnel is a universal radio holder (FIG. 1) such that, in theory, it will accommodate most or all radios on the market. Elastic shock cords are extended from the top of the holder down over the top and face of the radio and secured by way of snap or clip to the holder. However, the universal holder does not provide consistent and reliable retention for a wide range of radio sizes. When very short radios are placed in the holder, quite often the radio is inadequately secured and can come out of the holder in a dynamic environment such as running or getting in and out of a car (FIG. 2). In addition, the elastic shock cords are typically routed over the radio controls (FIGS. 2 and 3). This undesirable contact with the radio controls can inadvertently alter the radio controls.

Another method for carrying radio devices is a typical adjustable radio holder (FIG. 4). The holder utilizes a horizontal strap with a hook and loop or other adjustable fixture that can be adjusted in dimension to fit radios of varying width. As with the technique above, the holder does not adjust for variations in radio length. This results in inadequate retention for very short radios. A modified version of the adjustable radio holder employs elastic shock cords which are extended from the top of the holder down over the top and face of the radio and secured by way of snap or clip to the holder (FIG. 5). Routing the elastic shock cords over the radio controls can inadvertently alter the radio controls.

A proposal by Moore (U.S. Pat. No. 7,594,305) for a tether for an electronic device attaches by way of an axial cavity to an antenna or extrusion. The tether is disengaged from the antenna of the electronic device when the device is in use. The tether does not encase the electronic device being secured. The shortcoming with this method is that most radio devices are not designed to be carried solely by the antenna. The tether can exert a significant force radially to the antenna which can cause damage to the antenna and the electronic device. As such, the apparatus provides insufficient support to reliably carry a large radio in a dynamic environment.

There exists a need for a radio device holster that can securely retain a wide range of radio sizes without interfering with the controls of the radio device.

Some prior art references are, which are all different from our teachings below:
U.S. Pat. No. 7,594,305, by Moore, teaching “Socket engaging tether for electronic devices”

### SUMMARY OF THE INVENTION

Accordingly, the advantages of one or more aspects are:
a holster for carrying a radio device that can securely and reliably carry the device in a dynamic and demanding environment:
a holster for carrying a radio device that can securely and reliably carry the device without interfering with the controls of the device:
a holster for carrying a radio device that can securely and reliable carry a wide range of radio device sizes.

One embodiment features a holster body which holds the radio device. The holster body is adjacent to five sides of the radio device. As such, the radio device can only be inserted and removed from the holster in one direction. A lanyard assembly including two attachment members has a first attachment member which firmly attaches to the antenna of the radio device. The first attachment member preferably attaches at the base of the antenna since the antenna is often flexible. The second attachment member of the lanyard assembly engages with the holster.

The lanyard assembly exerts a force on the antenna predominantly in the axial direction of the antenna. This is the direction that the radio is inserted into and removed from the holster. This prevents movement in the direction of device removal and firmly secures the device in the holster. The holster body prevents the radio device from moving in the other degrees of freedom.

Other advantages of one or more aspects and a full understanding thereof will be apparent from a consideration of the following detailed description and claims taken together with the accompanying illustrations.

### BRIEF DESCRIPTION OF THE DRAWINGS

In the drawings, closely related figures have the same number but different alphabetic suffixes. Like parts are given like reference numerals in each of the drawings.

FIG. 1 shows a typical universal radio holster.

FIG. 2 shows a typical universal radio holster with a short radio.

FIG. 3 shows a typical universal radio holster with a tall radio.

FIG. 4 shows a typical adjustable radio holder.

FIG. 5 shows a typical adjustable radio holder with shock cord.

FIGS. 6A to 6C show front, side, and isometric views of a radio holster with antenna lanyard in accordance with one embodiment.

FIG. 7 shows a radio holster With antenna lanyard holding a radio.

FIG. 8 shows an antenna lanyard fixed to the antenna of a radio.

FIG. 9 shows a lanyard assembly in accordance with another embodiment.

FIG. 10 shows a lanyard assembly in accordance with another embodiment.

FIG. 11 shows a lanyard assembly in accordance with another embodiment.

FIG. 12 shows a lanyard cord routed through an attachment member.

FIGS. 13A and 13B show a radio holster with antenna lanyard in accordance with another embodiment.

FIG. 14 shows an attachment member with hook and loop assembly.

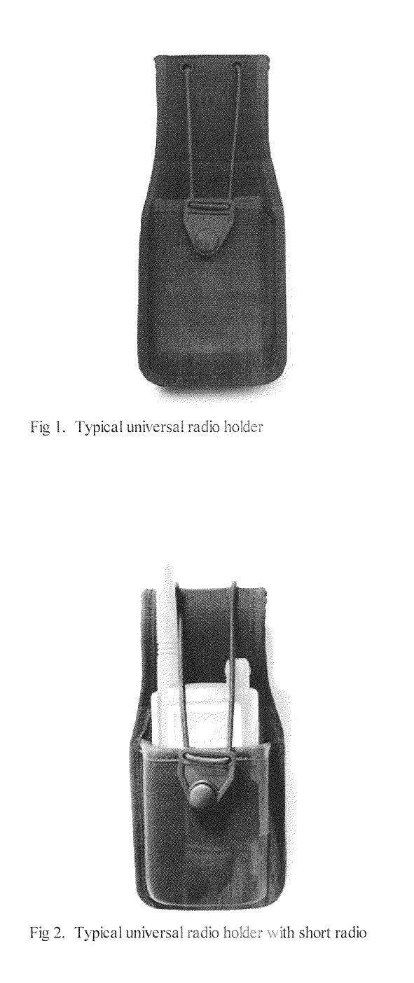

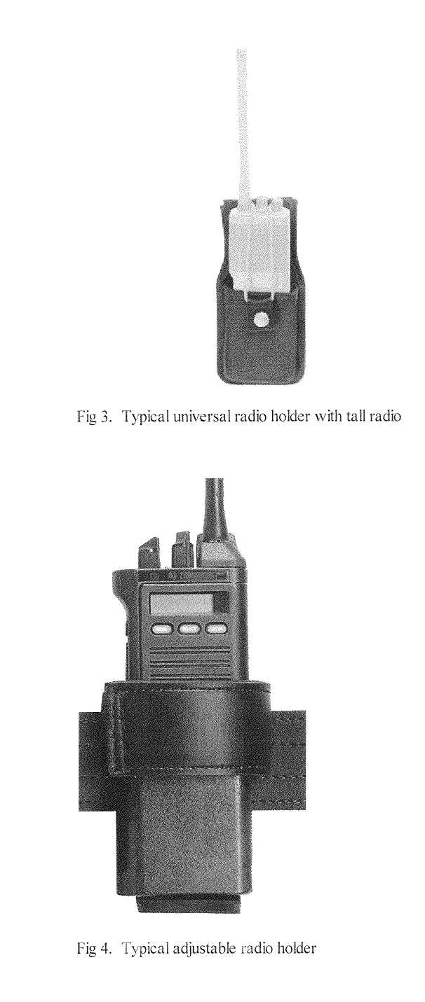

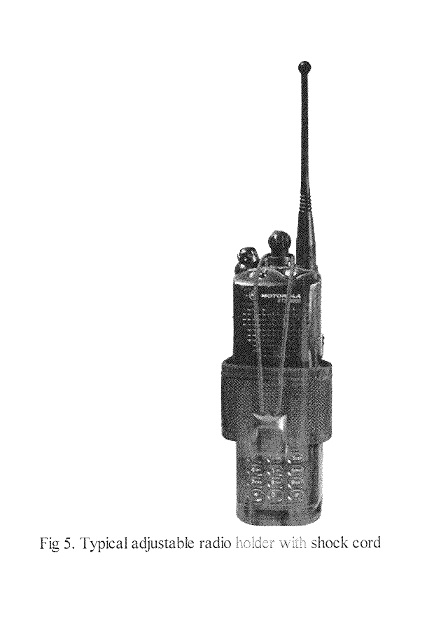

### DRAWINGS—REFERENCE NUMERALS

10 holster body
12 snap
13 mating snap
14 first attachment member
16 lanyard cord
18 second attachment member
20 supplemental fixture piece
22 hook and loop assembly

### DETAILED DESCRIPTION

### First Embodiment

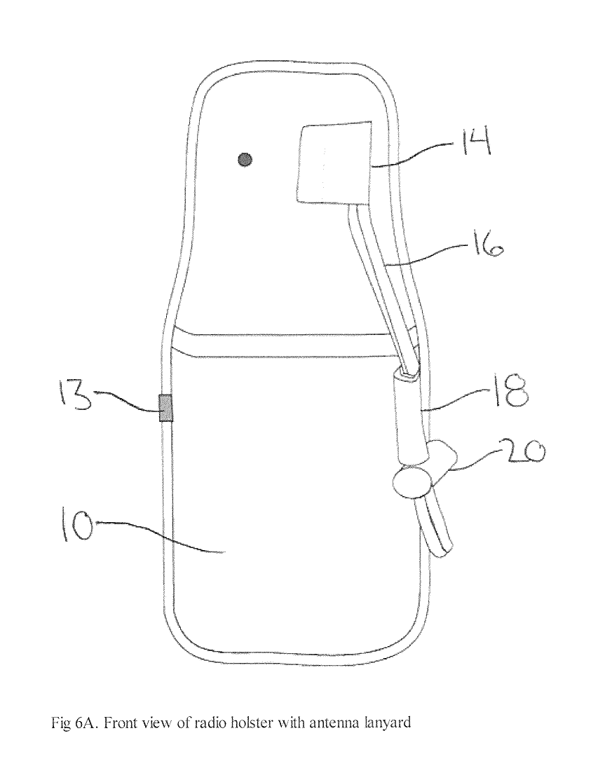

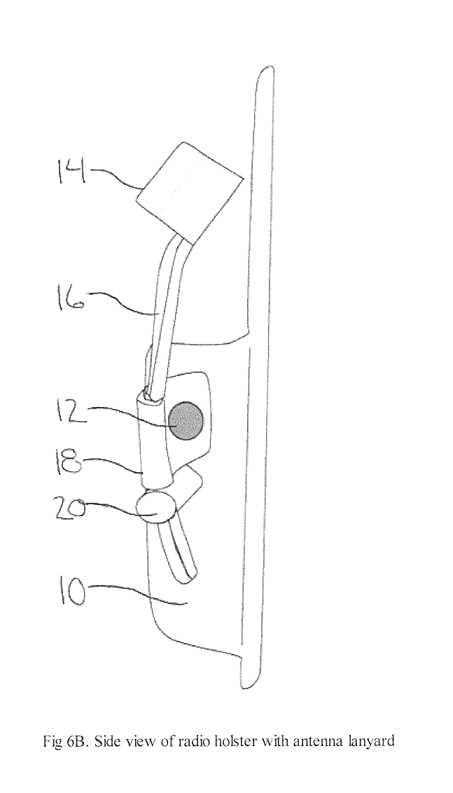

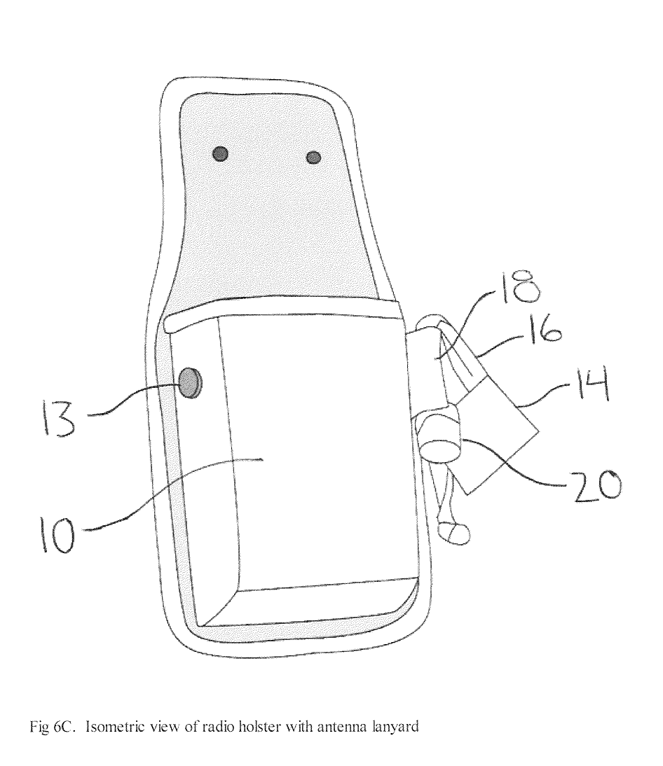

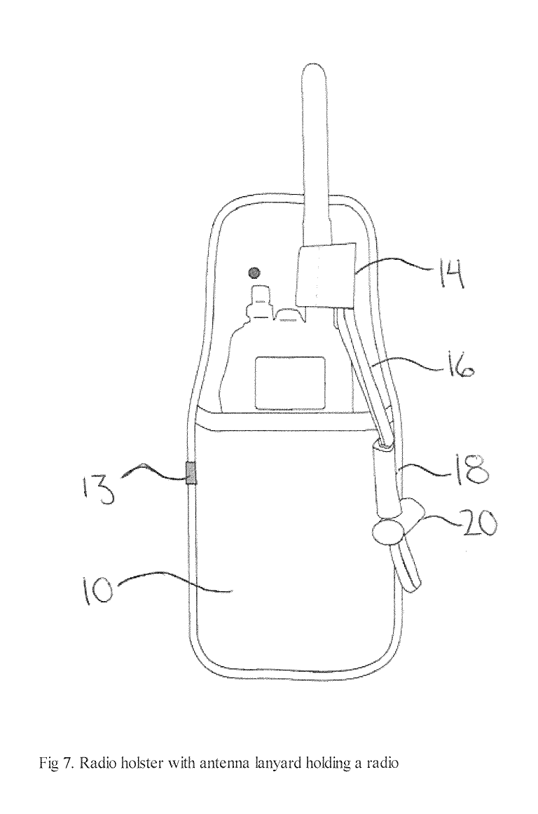

One embodiment of a radio holster with antenna lanyard is illustrated in FIGS. 6A to 6C. The radio holster comprises two assemblies, the first being a holster body 10 and the second being a lanyard assembly. Holster body 10 is a carrying apparatus comprising a back, front, bottom, left side, and right side. The collective dimensions of holster body 10 are large enough such that most radio devices can fit within.

The lanyard assembly comprises a first attachment member 14, a lanyard cord 16, a second attachment member 18, and a supplemental fixture piece 20. First attachment member 14 has an annular collar through which the antenna of the radio device fits. The annular collar of first attachment member 14 is fixed to the antenna through friction. The annular collar of first attachment member 14 is fixed to the antenna near the end of the antenna adjacent to the radio body. A permanent attachment is made between first attachment member 14 and lanyard cord 16, with lanyard cord 16 oriented substantially parallel to the annular collar. Lanyard cord 16 travels through second attachment member 18, allowing second attachment member 18 to move with respect to lanyard cord 16 and enabling the distance between first attachment member 14 and second attachment member 18 to be adjusted. The position of second attachment member 18 with respect to lanyard cord 16 is maintained in the adjusted location by clamping supplemental fixture piece 20 to lanyard cord 16. Supplemental fixture piece 20 secures the distance between first attachment member 14 and second attachment member 18.

Second attachment member 18 features a snap 12 on one face which engages with holster body 10 by way of a mating snap 13 fastened to holster body 10. One or more mating snaps are utilized on one or more faces of holster body 10. The multiple mating snap 13 locations enable the lanyard assembly to be routed such that it does not interfere with the radio device controls. Lanyard cord 16 is an elastic shock cord with no or a limited amount of potential strain which secures the radio device with a biased downward pre-load.

The holster body and components of the lanyard assembly can be made of material such as polymers, metals, cellulosic materials, ceramics, glass, biomaterials, nanomaterials, and composites.

### Operation

When a radio device is to be carried for the first time in the radio holster, first attachment member 14 is attached to the antenna of the radio device. The radio device is then placed in holster body 10. The distance between first attachment member 14 and second attachment member 18 is adjusted and supplemental fixture piece 20 is clamped to lanyard cord 16 in a position such that the radio device cannot move in the direction of removal when completely seated in holster body 10. Snap 12 of second attachment member 18 is then engaged with mating snap 13 of holster body 10. The distance between first attachment member 14 and second attachment member 18 requires no additional adjustment when the radio device is removed from and reinserted into holster body 10.

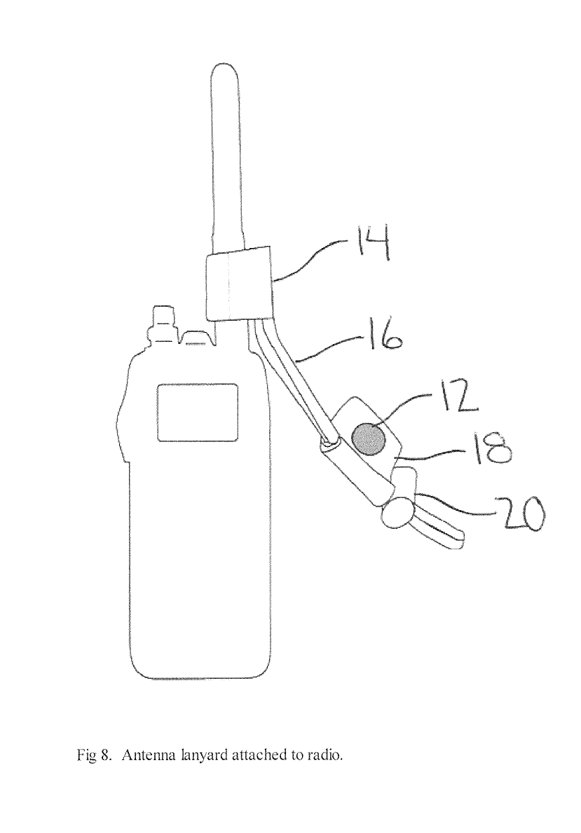

When the radio device is to be removed from holster body 10, first attachment member 14 remains attached to the antenna of the radio device while snap 12 of second attachment member 18 is disengaged from mating snap 13 of holster body 10. While the radio device is separated from holster body 10, the lanyard assembly remains attached to the antenna of the radio device, as shown in FIG. 8. When the radio device is placed back in holster body 10, snap 12 of second attachment member 18 is engaged with mating snap 13 of holster body 10.

When the user decides to use a different radio device with the radio holster, first attachment member 14 is removed from the antenna of the previous radio device. First attachment member 14 is then attached to the new radio device to be used with the radio holster. The distance between first attachment member 14 and second attachment member 18 is adjusted for the first time use following the same procedure as detailed above.

The holster body is attached to the belt worn around the waist of the user.

### Alternative Embodiments

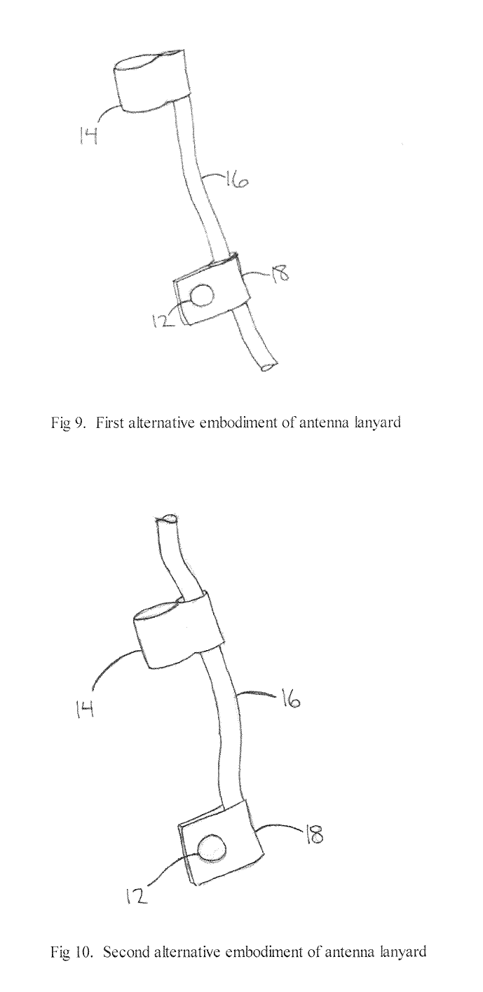

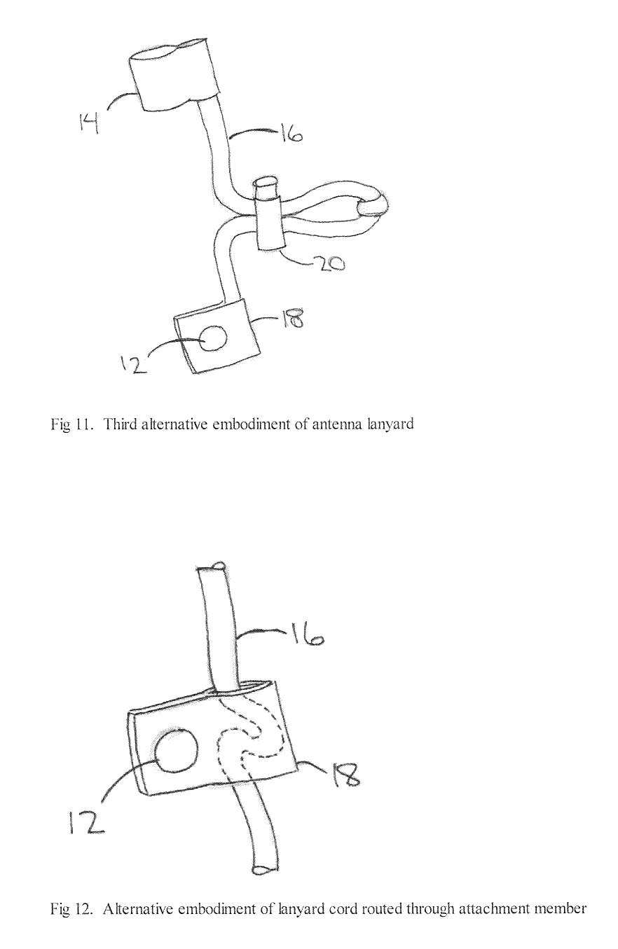

There are various possibilities with regard to the configuration of the lanyard assembly for adjusting the distance between the first attachment member and the second attachment member along the lanyard cord. FIG. 9 shows a lanyard assembly in which first attachment member 14 is permanently attached to lanyard cord 16 while second attachment member 18 is adjustable in position with respect to lanyard cord 16. Second attachment member 18 is secured in the adjusted position through high friction with lanyard cord 16. FIG. 10 shows a lanyard assembly in which first attachment member 14 is adjustable in position with respect to lanyard cord 16 while second attachment member 18 is permanently attached to lanyard cord 16. First attachment member 14 is secured in the adjusted position through high friction with lanyard cord 16. FIG. 11 shows a lanyard assembly in which both first attachment member 14 and second attachment member 18 are permanently attached to lanyard cord 16.

Alternative methods for securing the attachment members in position on the lanyard cord can be used. FIG. 12 shows lanyard cord 16 routed along a non-linear path through second attachment member 18. Alternatively, a knot can be used to secure the second attachment member at the desired location along the lanyard cord.

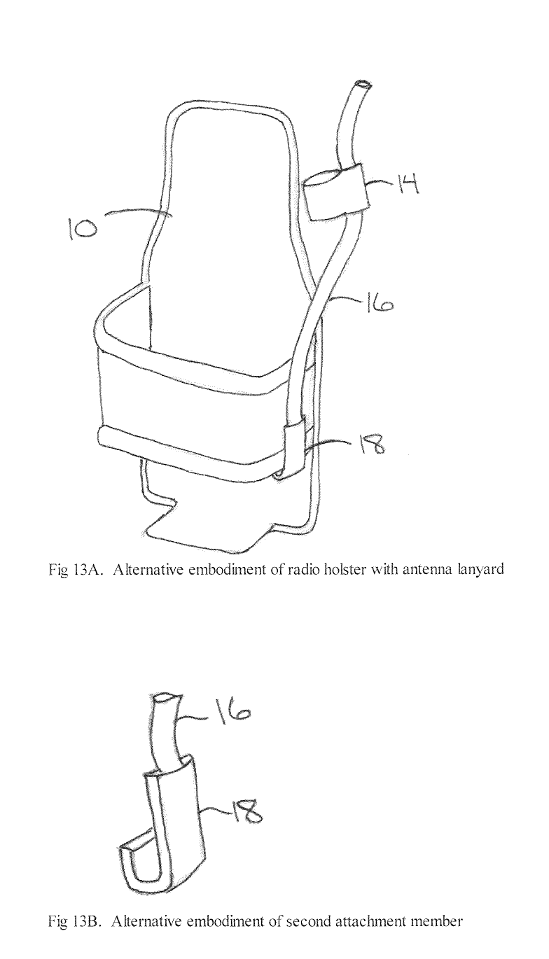

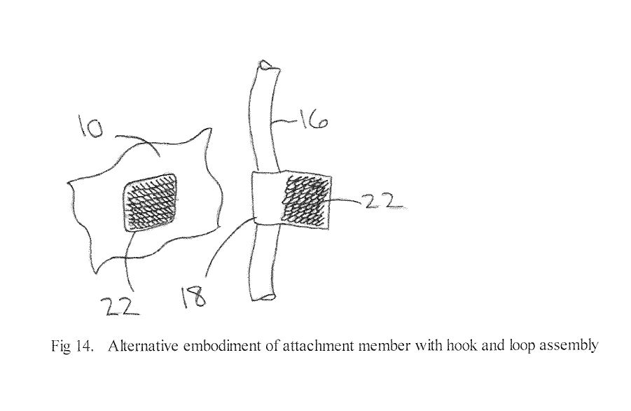

There are various possibilities for attaching the second attachment member to the holster body. FIG. 14 shows an embodiment in which second attachment member 18 utilizes one half of a hook and loop assembly 22. The other half of hook and loop assembly 22 is fixed on one or more faces of holster body 10. FIGS. 13A and 13B show an embodiment in which one or more of the front, left, or right faces of holster body 10 is not contiguous to the bottom face of holster body 10. Second attachment member 18 utilizes a hook which secures to lower edge of the front, left, or right face of holster body 10.

Alternatively, the lanyard cord 16 can he a non-elastic member.

### Conclusion, Ramifications, and Scope

Accordingly, the reader will see that at least one embodiment of the radio holster with antenna lanyard provides a more reliable and more secure method for carrying a radio device while preventing the radio device from moving or shifting in a very dynamic environment. The radio holster with antenna lanyard has the additional advantage in that it will not affect or inadvertently alter the controls of the radio device. Furthermore, the radio holster provides the above advantages while compatible with a range of radio devices varying widely in size.

Although the above description contains many specificities, these should not be construed as limiting the scope of the embodiments but as merely providing, illustrations of some of several embodiments. Thus the scope of the embodiments should be determined by the appended claims and their legal equivalents, rather than by the examples given.

What is claimed is:

1. An apparatus, comprising:
a holster body of sufficient size to support a radio device;
a lanyard assembly detachable from said holster body;
said lanyard assembly comprising a first attachment member, a lanyard cord, and a second attachment member;
a first means for attaching said first attachment member to said radio device;
a second means for attaching said second attachment member to said holster body.

2. An apparatus according to claim 1 wherein the distance between said first attachment member and said second attachment member along said lanyard cord is adjustable.

3. An apparatus according to claim 1 wherein said first means for attaching said first attachment member to said radio device is engaged to an antenna of said radio device.

4. An apparatus according to claim 1 wherein said first means for attaching said first attachment member to said radio device utilizes a collar which wraps at least halfway around the perimeter of said antenna of said radio device.

5. An apparatus according to claim 1 wherein at least one of said attachment members is secured to said lanyard cord by friction.

6. An apparatus according to claim 1 wherein the distance between said first attachment member and said second attachment member is adjustable by routing said lanyard cord along a tortuous path through at least one of said attachment members.

7. An apparatus according to claim 1 wherein said lanyard cord of said lanyard assembly is elastic in nature.

8. An apparatus according to claim 1 wherein said lanyard cord of said lanyard assembly is axially rigid in nature.

9. An apparatus according to claim 1 wherein said holster body has one or more distinct locations to attach said second attachment member of said lanyard assembly.

10. An apparatus according to claim 1 wherein said second means for attaching said second attachment member to said holster body is a snap.

11. An apparatus according to claim 1 wherein said second means for attaching said second attachment member to said holster body is a hook and loop assembly.

12. An apparatus according to claim 1 wherein said lanyard assembly further comprises a supplemental piece for securing the distance between said first attachment member and said second attachment member along said lanyard cord.

13. An apparatus according to claim 1 wherein the distance between said first attachment member and said second attachment member along said lanyard cord is adjustable and the distance is secured by a slide clamp.

14. An apparatus according to claim 1 wherein the distance between said first attachment member and said second attachment member along said lanyard cord is adjustable and the distance is secured by a knot.
